(19) United States
(12) Patent Application Publication
(10) Pub. No.: US 2026/0221368 A1
(43) Pub. Date: Jul. 30, 2026

(54) Protection circuit for an electrical installation, associated protection device and protection method

(71) Applicant: MERSEN France SB SAS, Saint-Bonnet-De-Mure (FR)

(72) Inventors: Laurent MILLIERE, Lyon (FR); Gianfranco DE PALMA, Saint Barthélémy d’Anjou (FR); Jean-François OEUVRARD, Lyon (FR)

(21) Appl. No.: 19/452,994

(22) Filed: Jan. 20, 2026

(30) Foreign Application Priority Data
Jan. 28, 2025 (FR) 2500889

(51) Int. Cl. H01H 85/02; H01C 7/12; H01H 85/18; H01H 85/38; H01H 85/048

(52) U.S. Cl. CPC H01H 85/0241; H01C 7/126; H01H 85/18; H01H 85/38; H01H 2085/0258; H01H 2085/0486; H01H 2085/381

(57) ABSTRACT

This protection circuit for an electrical installation includes a fuse element and a resistive element, preferably a metal oxide varistor, which is connected in parallel with the fuse element. A movable contact is arranged serially with the resistive element and the fuse element. The movable contact is configured to switch, under the effect of a return member, between a closed conduction position and an open position. A soldering point is provided to hold the movable contact in the closed position. When the fuse element melts, an arc voltage is established across the resistive element, which then generates sufficient heat to melt the soldering point, allowing the movable contact to move to the open position and opening the protection circuit.

This invention relates to a protection circuit for an electrical installation. It further relates to a protection device for an installation comprising such a protection circuit. Finally, it relates to a method for protecting an electrical installation comprising a step of providing such a protection circuit or such a protection device.

Cartridge fuses, also known simply as "fuses", are well-known and widely used protection devices for electrical installations. These devices include a fuse element that melts when a fault current greater than a predetermined critical current flows through it, thereby interrupting the electrical link and the flow of the fault current. Fuses have already been the subject of numerous developments, leading to a variety of architectures.

However, whatever the proposed architecture, two issues remain. The first concerns the fuse's ability to melt when a fault current flows through it. The second issue concerns current limitation after the fuse element has melted, when the fuse is in an "open" state. In some cases, the electrical resistance of the fuse in the open state is not sufficient to ensure interruption of the fault current, i.e. protection of the installation in the event of an electrical fault, which can lead to breakdowns, damage to property, accidents, or fires. The problem is all the more critical in the case of electrical installations operating on direct current. Some standards, or other technical requirements, demand, for example, that the resistance in the open state be as high as possible, typically greater than 1 MΩ (megaohms).

The aim of the invention is therefore to offer a protection circuit that makes the protection function of the electrical installation more reliable, in particular by guaranteeing interruption of the leakage current after the fuse element has melted, while providing galvanic isolation.

To this end, the invention relates to a protection circuit for an electrical installation. This protection circuit comprises:

a first terminal,

a second terminal, separate from the first terminal,

a fuse element, which is arranged between the first terminal and the second terminal, and which has two opposite ends, the two ends including a first end, which is connected to the first terminal, and a second end, the fuse element being configured to melt when an electric current flowing between the first end and the second end exceeds a predetermined critical current that is characteristic of the fuse element, and

a resistive element, which is arranged between the first terminal and the second terminal, and which has two opposing leads, including a first lead and a second lead, the first lead being connected to the first terminal.

According to the invention, the second end is connected to the second lead, the protection circuit further comprising:

a movable contact, which is arranged between the second lead and the second terminal and which is configured to switch between a closed position, in which the movable contact electrically connects the second lead to the second terminal, and an open position, in which the movable contact is at a distance from the second lead and does not electrically connect the second lead to the second terminal;

a return member, which tends to move the movable contact from the closed position to the open position, and

a soldering point, which is configured to hold the movable contact in the closed position when the soldering point is not melted, and to allow the movable contact to move from the closed position to the open position under the effect of the return member when the soldering point is melted.

Thanks to the invention, the appearance of an arc voltage at the terminals of the protection circuit leads, during and after the melting of the fuse element, to a deflection of the current through the resistive element, causing the resistive element to heat up and then the soldering point to melt. The movable contact then swings open, creating a physical gap in the protection circuit. The open position of the movable contact thus has a higher resistance in the open state than the resistance of the fuse alone in the melted state, notably because of the space separating the resistive element from the movable contact in the open position, interrupting the passage of current after the melting of the fuse element, while providing galvanic insulation.

According to other advantageous aspects of the invention, the protection circuit comprises one or more of the following features, taken in isolation or in any technically possible combinations:

The resistive element is a non-linear resistor.

The resistive element is a metal oxide varistor.

The resistive element has a rated voltage, known as the first rated voltage, which is strictly lower than a rated voltage of the protection circuit, known as the second rated voltage,

while the resistive element is configured to generate sufficient heat to melt the older joint when a voltage greater than the first nominal voltage is applied between the first lead and the second lead.

The first rated voltage is between 30% and 70% of the second rated voltage.

The protection circuit comprises:

an arc shield, which is movable between an engaged position, in which the arc shield is interposed between the resistive element and the movable contact in the open position, preventing the movable contact from moving from the open position to the closed position, and a retracted position, in which the arc shield does not prevent the movable contact from moving from the open position to the closed position,

a secondary return member, which is configured to return the arc shield from its retracted position to the engaged position.

The protection circuit is configured to have a resistance greater than 1 GΩ when the movable contact is in the open position.

The invention also relates to a protection device for an electrical installation, the protection device comprising:

a housing, which is made of an electrically insulating material and which defines a cavity, the cavity comprising a first and a second distinct opening; and

an example of the protection circuit as previously defined, the protection circuit being housed in the cavity, the first terminal being positioned at the first opening and the second terminal being positioned at the second opening.

### Advantageously:

the protection device further comprises a powdery material, in particular sand, which at least partially fills the cavity and is intended to help quench an electric arc.

The invention also relates to a method of protecting an electrical installation, the protection method being implemented with the electrical circuit as previously defined or with the protection device as previously defined, the protection method comprising the following steps:

an initial step, during which a current flowing between the first terminal and the second terminal is less than the critical current and flows through the fuse element and the movable contact;

a first melting step, starting when the current becomes greater than the critical current, comprising a melting of the fuse element;

a breaking step, starting when the fuse element breaks, causing an arc voltage to be established between the first lead and the second lead;

a second melting step, starting when the fuse element is melted following the first melting step, comprising a circulation of at least part of the leakage current between the first terminal and the second terminal through the resistive element and the movable contact, the resistive element generating heat, causing the soldering point to heat and melt due to the heat generated by the resistive element;

a switchover step, starting when the soldering point has melted, comprising the switching over of the movable contact to the open position.

This method has the same advantages as those mentioned above for the protection circuit of the invention. dvantageously: the protection circuit is as defined above and comprises a copy of the arc shield,

Advantageously:

the protection circuit is as defined above and comprises a copy of the arc shield,

the method further comprises a securing step, which begins when the movable contact moves to the open position and which comprises moving the arc shield from the retracted position to the engaged position.

The invention will become clearer on reading the following description of an embodiment of a protection circuit, a protection device and a protection method, in accordance with its principle, given solely by way of non-limiting example, and made with reference to the drawings in which:

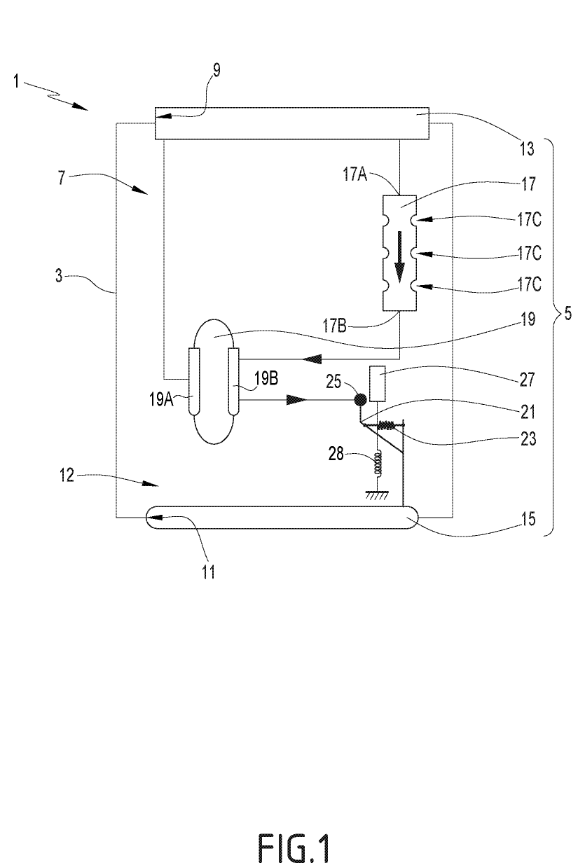

FIG. 1 is a diagram of a protection device according to the invention;

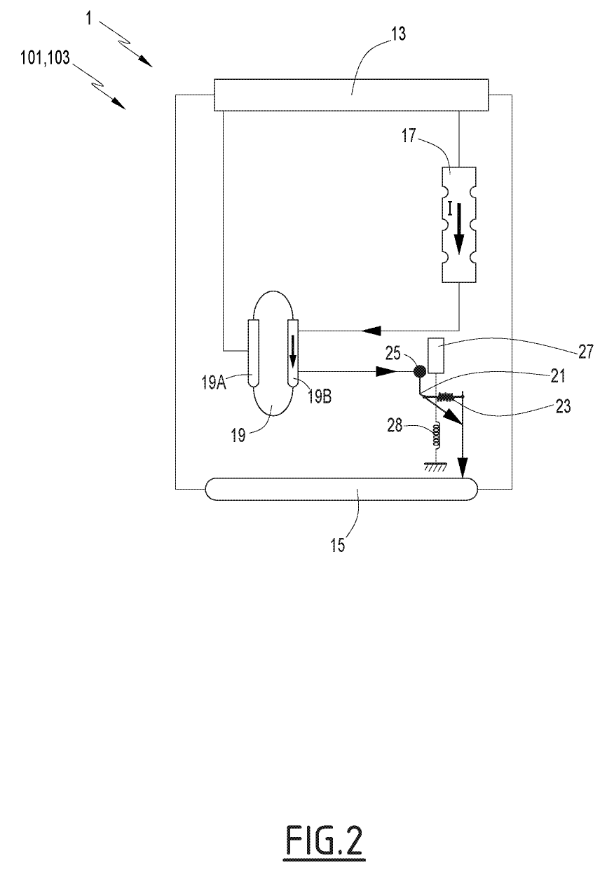

FIG. 2 is a diagram of the protection device of FIG. 1 during an initial step of a protection method according to the invention;

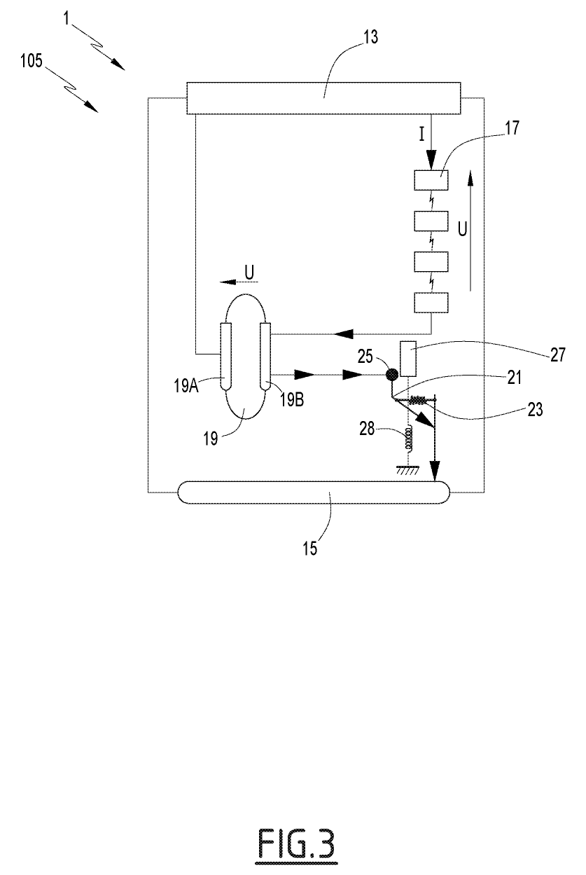

FIG. 3 is a schematic diagram of the protection device shown in FIG. 1 during a breaking step of the protection method;

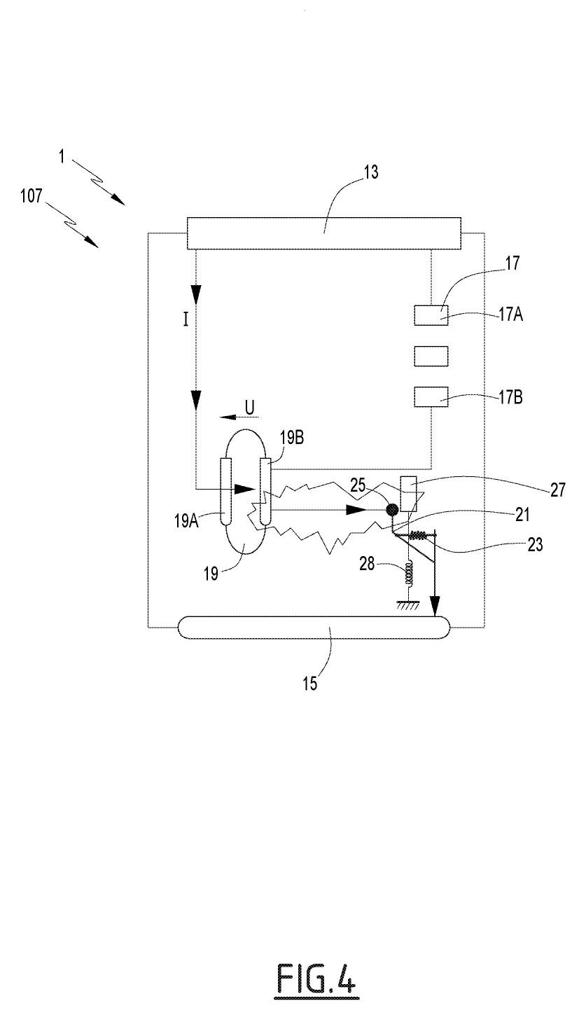

FIG. 4 is a diagram of the protection device of FIG. 1 during a second melting step of the protection method;

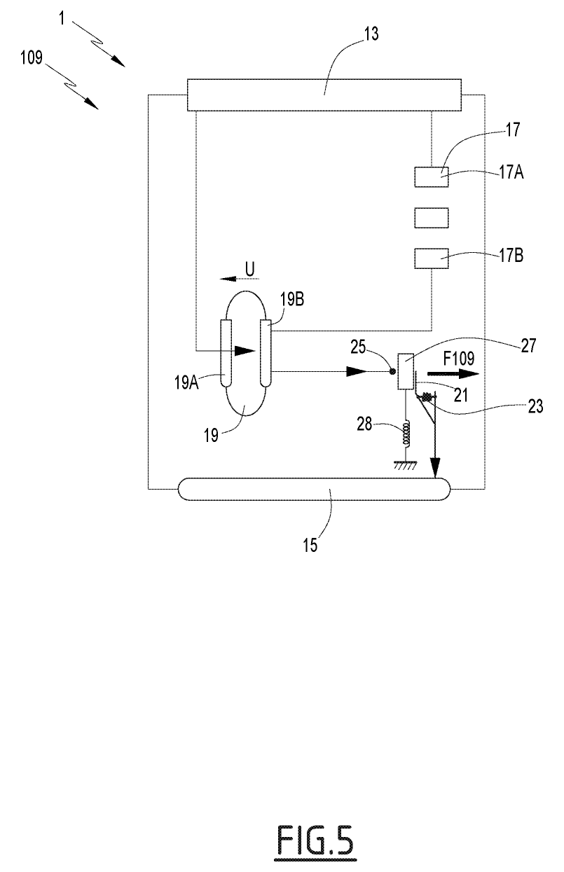

FIG. 5 is a diagram of the protection device of FIG. 1 during a switchover step of the protection method, and

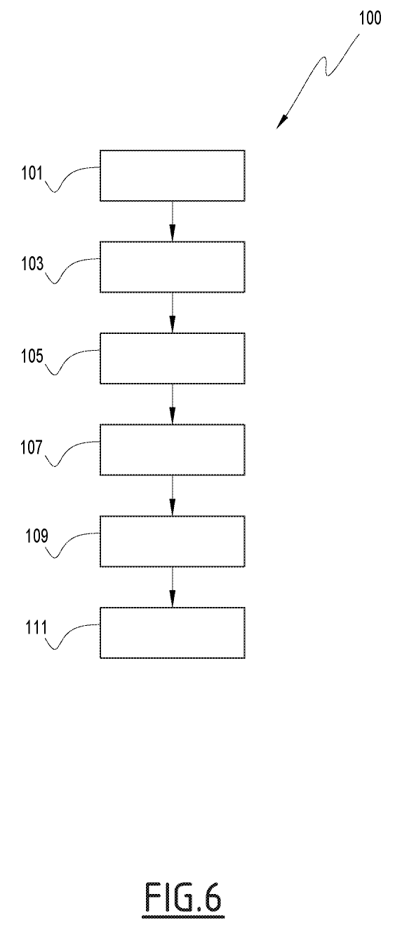

FIG. 6 is a block diagram illustrating the protection method.

FIG. 1 shows a protection device 1. The protection device 1 is designed to protect an electrical installation, not shown, against electrical faults such as short circuits or overcurrents.

The protection device 1 is a fuse cartridge, also known simply as a "fuse". The protection device 1 comprises a housing 3 and a protection circuit 5, which is accommodated in the housing 3. The housing 3 makes it easy to protect, handle and replace the protection device 1, while providing an electrical connection between the protection circuit 5 and the electrical installation. To achieve this, the housing 3 is made of an electrically insulating material, for example ceramic or a synthetic polymer material. The housing 3 delimits a cavity 7 and comprises two separate openings, including a first opening 9 and a second opening 11, through which the cavity 7 opens out towards the outside of the housing 3. The housing 3 is, for example, cylindrical or parallelepipedic in shape, with the first opening 9 and the second opening 11 preferably located at opposite ends of the housing 3.

Advantageously, the cavity 7 is at least partially filled with a powdered material 12, in particular sand, which is designed to help quench an electric arc that may occur in the protection circuit 5, by absorbing some of the energy of the electric arc. This is discussed in more detail below.

The protection circuit 5 is housed in the cavity 7, with each of the two openings 9 and 11 providing an electrical connection between the protection circuit 5 and the electrical installation.

The protection circuit 5 comprises a first terminal 13, a second terminal 15 separate from the first terminal 13, a fuse element 17, a resistive element 19, a movable contact 21, a return member 23 and a soldering point 25. In the example shown in FIGS. 1 to 5, the protection circuit 5 advantageously comprises an arc shield 27.

The first terminal 13 and the second terminal 15 are respectively positioned at the first opening 9 and the second opening 11, so as to enable the protection circuit 5 to be connected to the electrical installation. The first and second terminals 13 and 15 are generally metal parts or conducting wires, which protrude from the cavity 7 through the first and second openings 9 and 11 respectively, as in FIG. 1. Alternatively, not shown, the first and second terminals 13 and 15 are metal parts or conductive wires located inside the cavity 7, respectively set back from the first and second openings 9 and 11. In both cases, the first and second terminals 13 and 15 are accessible to a conductive element of the electrical installation, enabling electrical connections to be made between the protection circuit 5 and the electrical installation.

The fuse element 17 is arranged in the cavity 7 between the first terminal 13 and the second terminal 15. The fuse element 17 comprises two opposite ends, the two ends including a first end 17A and a second end 17B, the first end 17A being connected to the first terminal 13. The fuse element 17 is configured to melt when the current I flowing between the first end 17A and the second end 17B exceeds a predetermined threshold called the "critical current". The fuse element 17 is a fusible strip, made for example of copper or one of its alloys, silver or one of its alloys, aluminium or one of its alloys, or a combination of these materials, for example a copper/silver combination. The fuse element 17 generally comprises at least one portion having a section of reduced size compared with the rest of the fuse element, referred to as the "reduced section" 17C, which has a higher electrical resistance than the rest of the fuse element 17 and which tends to heat up preferentially when the fuse element 17 is passed through by an electrical current. In the example shown, the fuse element 17 comprises three reduced sections 17C. Thus, when the electrical current I flowing through the fuse element 17 exceeds the critical current, the temperature of the material of the fuse element 17 exceeds a melting temperature of the material, causing the fuse element 17 to melt at one or more of the reduced sections 17C. It is understood that the value of the critical current depends in particular on the geometry and nature of the material of the fuse element 17. The number, arrangement, and shape of the reduced sections 17C is not limitative. In a variant not shown, a plurality of fuse elements 17 are mounted in parallel. In normal operation, a current I flowing through a part of the electrical installation connected to the protection device 1 passes through the protection circuit 5. The purpose of the protection device 1 is to interrupt the flow of current I if the current I exceeds the critical current.

The resistive element 19 is also arranged in the cavity 7 between the first terminal 13 and the second terminal 15. The resistive element 19 has two opposing leads, including a first lead 19A and a second lead 19B. The first lead 19A is connected to the first terminal 19B and the second lead 19B is connected to the second end 17B. In other words, the resistive element 19 is connected in parallel with the fuse element 17. In the example shown in FIG. 1, leads 19A and 19B comprise added electrical contacts.

The resistive element 19 is advantageously a non-linear resistor. Non-linear resistance refers to a component whose electrical resistance, expressed in Ohms, varies as a function of an electrical voltage applied to the component. Preferably, the non-linear resistance is said to have a negative coefficient, i.e. the value of the electrical resistance decreases as the applied electrical voltage increases. In the example shown, the resistance of the resistive element 19 decreases as a function of a voltage U applied between the first lead 19A and the second lead 19B. In a variant not shown, the resistive element 19 is a linear resistor. Preferably, the non-linear resistor is a metal oxide varistor, advantageously thermally protected. In the preferred example shown, the metal oxide varistor is a zinc oxide varistor, also known as a ZnO varistor.

In the advantageous case where the resistive element 19 is a metal oxide varistor, the resistive element 19 has a predetermined nominal resistive element voltage, referred to as the first nominal voltage U19, which is characteristic of the resistive element 19. The first nominal voltage U19 is an electrical voltage at which the metal oxide varistor becomes conductive, when said voltage is applied between the first lead 19A and the second lead 19B of the varistor.

In the context of the invention, the first rated voltage U19 is strictly lower than a rated voltage of the protection circuit 5, referred to as the second rated voltage U5. The second rated voltage U5 corresponds to the maximum voltage that the protection circuit 5 can withstand without risk of damage or failure. In particular, when the protection device 1 is to be used in an electrical installation supplied by a DC power source, the second rated voltage U5 corresponds to a DC voltage from the power source.

Conversely, if the first rated voltage U19 is too low compared with the second rated voltage U5, there is a risk that the resistive element 19 will deteriorate, in particular explode, when the second rated voltage U5 is applied across the resistive element. The first nominal voltage U19 is preferably between 30% and 70% of the second nominal voltage U5, and even more preferably between 40% and 60% of the second nominal voltage U5, for example 50% of the second nominal voltage U5. The resistive element 19 is characterised by a resistance R19, expressed in Ohms, the resistance R19 advantageously being a function of the voltage applied to the leads of the resistive element 19. When an electrical voltage U is applied to the leads of the resistive element 19, the resistive element 19 gives off heat, in particular by Joule effect. In direct current, the heat generated is proportional to the voltage U applied to the square, divided by the resistance R19; in other words proportional to U²/(R19).

The movable contact 21 is arranged between the second lead 19B and the second terminal 15. The movable contact 21 is made, for example, of a deformable metal element. The movable contact 21 is configured to switch between a closed position and an open position. FIGS. 1 to 4 show the movable contact 21 in the closed position, so the protection circuit 5 is in a closed configuration, while FIG. 5 shows the movable contact 21 in the open position. The protection circuit 5 is then in an open configuration.

In the closed position, the movable contact 21 electrically connects the second lead 19B to the second terminal 15. The current I can then flow between the second lead 19B and the second terminal 15.

In the open position, the movable contact 21 is at a distance from the second lead 19B and does not electrically connect the second lead 19B to the second terminal 15. In other words, in the open position there is a non-zero gap between the movable contact 21 and the second lead 19B. This space is filled with air or sand and prevents the flow of current I between the second lead 19B and the second terminal 15. In other words, the movable contact 21 has an apparent resistance when it is in the open position. The protection circuit 5 is configured so that, in the open configuration, this apparent resistance is greater than 1 GΩ (gigaohms), which translates into conditions on the distance between the second lead 19B and the movable contact 21 in the open position and on the materials making up these elements, and can be obtained empirically.

The return member 23 is, for example, a spring or an elastically deformable metal element, at least part of which is integral with the movable contact 21. The return member 23 tends, by resilient return, to move the movable contact 21 from the closed position to the open position. Thus, in the absence of other forces, the movable contact 21 tends to position itself naturally in the open position under the effect of the return member 23. During manufacture of the protection circuit 5 or protection device 1, the movable contact 21 is held in the closed position by means of the soldering point 25.

In FIGS. 1 to 5, the soldering point 25 is shown schematically at a distance from the resistive element 19, although this may be different in reality. Advantageously, the soldering point 25 is formed directly on the second lead 19B. In a variant not shown but nevertheless advantageous, the movable contact 21 and the return member 23 form part of the same element, for example a metal strip which is resiliently deformable. Such a movable contact is sometimes called a "pop-contact".

The soldering point 25 is made of an electrically conductive material which is solid at room temperature and has a relatively low melting temperature, typically between approximately 70°C and approximately 140°C, preferably between approximately 80°C and approximately 120°C, and even more preferably between approximately 90°C and approximately 100°C. “Approximately" means "within manufacturing and measurement uncertainties", for example ±5°C. The material of the soldering point 25 is, for example, a metallic or polymeric material.

The resistive element 19 is configured to generate sufficient heat to melt the soldering point 25 when the voltage U applied between the first lead 19A and the second lead 19B is greater than the first nominal voltage U19. In other words, the soldering point 25 is configured to melt under the effect of the heat generated by the resistive element 19, when a sufficient electrical voltage is applied to the resistive element 19.

When the soldering point 25 is in solid form, which is the case when the protection device 1 is in a so-called "initial state", as shown in particular in FIG. 1, the soldering point 25 holds the movable contact 21 in contact with the second lead 19B. In other words, as long as a temperature of the soldering point 25 is below the melting temperature associated with the material of the soldering point 25, the soldering point 25 holds the movable contact 21 in the closed position.

When a temperature of the soldering point 25 reaches or exceeds the melting temperature associated with the material of the soldering point 25, in other words when the soldering point 25 is melted, the movable contact 21 is no longer held in the closed position. The spring return of the return member 23 moves the movable contact 21 away from the second lead 19B. In other words, when the soldering point 25 is melted, it allows the movable contact 21 to move from the closed position to the open position under the effect of the return member 23.

The arc shield 27 is used to protect the movable contact 21 and the second terminal 15 from any arcs generated when the movable contact 21 moves from the closed position to the open position. The arc shield 27 is made of an electrically insulating material, for example a synthetic polymer material. The arc shield 27 can be moved between:

an engaged position, in which the arc shield 27 is interposed between the resistive element 19 and the movable contact 21 in the open configuration, preventing the movable contact 21 from moving from the open configuration to the closed position, and

a retracted position, in which the arc shield 27 does not prevent the movable contact 21 from moving from the open configuration to the closed position.

The arc shield 27 is shown in the retracted position in FIGS. 1 to 4, and in the engaged position in FIG. 5.

The protection circuit 5 further comprises a secondary return member 28, which is configured to return the arc shield 27 from its retracted position to the engaged position. The secondary return member 28 comprises, for example, one or more springs.

As long as the movable contact 21 is in the closed position, the arc shield 27 is held in the retracted position. For example, the movable contact 21 physically blocks the arc shield 27 in the retracted position.

When the protection circuit 5 or the protection device 1 is manufactured, the protection circuit 5 is in an initial state in which:

the fuse element 17 is not melted, and

the soldering point 25 is not melted and holds the movable contact in the closed position, which holds the arc shield 27 in the retracted position.

When the soldering point 25 melts, the movable contact 21 moves from the closed position to the open position under the effect of the return member 23, and in so doing the movable contact 21 allows the arc shield 27 to move from the retracted position to the engaged position, under the effect of the secondary return member 28. The arc shield 27 thus forms a physical barrier between the movable contact 21 and the resistive element 19, cutting off any electric arc between the resistive element 19 and the movable contact 21, and eliminating any risk of accidental closure of the movable contact 21.

A method 100 for protecting the electrical installation is shown schematically in FIG. 6 and described in the rest of the description. The protection method 100 is carried out using the protection device 1. Alternatively, the protection method is carried out by means of the protection circuit 5, independently of the protection device 1.

The protection method 100 comprises an initial step 101, a first melting step 103, a breaking step 105, a second melting step 107 and a switching step 109.

In the initial state of the protection circuit 5, as shown in FIGS. 1 and 2, neither the fuse element 17 nor the soldering point 25 is melted and the movable contact 21 is in the closed position. The arc shield 27 is in the retracted position.

FIG. 2 shows the flow of current during the initial step 101 and the first melting step 103. The flow of current through the various elements of the protection circuit 5 is represented by a series of arrows.

During the initial step 101, the leakage current I is less than the critical current characterising the fuse element 17 and flows between the first terminal 13 and the second terminal 15 through the fuse element 17 and the movable contact 21. In fact, the equivalent resistance of a path passing through the fuse element 17 and the movable contact 21 is much lower than the resistance between the first lead 19A and the second lead 19B of the resistive element 19.

The initial step 101 lasts as long as the current I is less than the critical current.

The first melting step 103 begins when the current I exceeds the critical current. During the first melting step 103, the current I continues to flow through the fuse element 17 and the movable contact 21 and the fuse element 17 melts.

After a certain period of time depending on the protection circuit 5 and the current I, the fuse element 17 breaks at one or more points, in particular at the reduced sections 17C, causing one or more electric arcs to appear between the first end 17A and the second end 17B of the fuse element 17, as shown in FIG. 3. The electrical arc(s) cause an arc voltage U to be established between the first end 17A and the second end 17B of the fuse element 17, in other words, by continuity of the electrical potentials, between the first lead 19A and the second lead 19B of the resistive element 19. As the voltage across the resistive element 19 is non-zero, a current begins to flow through the resistive element 19, thereby reducing the current flowing through the element.

Some of the current I then flows through the resistive element 19, while the rest of the current I flows through the fuse element 17, in the form of an electric arc. This is shown in FIG. 3 and corresponds to the breaking step 105.

The passage of part of the current I through the resistive element 19, arranged in parallel with the fuse element 17, quickly reduces the electric arc. As fuse element 17 melts and is destroyed, the total arc length increases, which in turn increases the arc voltage. It is understood that, at most, the arc voltage is equal to the operating voltage of the electrical installation, in other words the second rated voltage U5 of the protection circuit 5. As the resistive element 19 is advantageously non-linear and has a negative coefficient, the apparent electrical resistance of the resistive element 19 decreases as the arc voltage increases, which allows the current flowing through the resistive element 19 to increase, and therefore reduces the current flowing through the fuse element 17 – helping to quench the electric arc(s).

Once the arc or arcs have been quenched, the protection device 5 is in the configuration shown in FIG. 4. The entire current I then flows through the resistive element 19. It is understood that as soon as an electric current flows through the resistive element 19, the resistive element 19 begins to heat up. In particular, since the resistive element 19 is configured to generate sufficient heat to melt the soldering point 25 when a voltage greater than the first nominal voltage U19 is applied between the first lead 19A and the second lead 19B, the soldering point 25 is heated and begins to melt as a result of the heat generated by the resistive element 19. This is the second melting step 107.

The switchover step 109, shown in FIG. 5, begins when the soldering point 25 is melted. Due to the characteristics of the movable contact 21 and the return member 23 explained above, the movable contact 21 switches over to the open position. The movement of the movable contact 21 from the closed position to the open position is shown by arrow F109 in FIG. 5. Because of the equivalent resistance of the space created between the second lead 19B and the movable contact 21, the current I can no longer flow between the first terminal 13 and the second terminal 15.

In addition, the movable contact 21 in the open position physically provides a gap in the protection circuit 5. It is therefore understood that the invention makes it possible to ensure a much greater resistance in the open state, corresponding to the open position of the movable contact 21, than the resistance in the open state obtained by the fuse element 17 alone. In particular, the invention makes it possible to achieve an open-state resistance greater than 1 GΩ (gigaohms, i.e.10⁹ Ohms), which reduces leakage currents when used with a DC power source, in other words provides galvanic protection. In addition, the ability of the protection device 1 to interrupt small currents is not affected by the present structure compared with the fuse element 17 alone.

In the case where the protection circuit 5 comprises the arc shield 27, the protection method advantageously includes a securing step 111, which is subsequent to the switchover step 109, the securing step 111 starting when the movable contact 21 switches into the open position and comprising the movement of the arc shield 27 from the retracted position to the engaged position. The securing step 111 provides additional security by placing a physical barrier between the movable contact 21 and the resistive element 19.

At the end of the protection method described above, the protection device 1, owing to the housing 3, can easily be replaced by a new protection device 1 in its initial state, i.e. with the fuse element 17 and the soldering point 25 unmelted, so that the electrical installation can operate again.

In the example shown, the protection device 1 delimits the cavity 7, which receives the protection circuit 5 and the fuse element 17, the cavity 7 was advantageously filled with a powdery material 12, in particular sand.

Alternatively, not shown, the fuse element 17 is housed in a fusible cartridge, which is itself housed in the cavity 7 and which is advantageously filled with a powdery material, such as sand. This makes it easier to handle the fuse element 17, particularly when manufacturing the protection circuit 5, as fuse strips are typically very thin and fragile.

In another variant, not shown, the protection circuit 5 is used outside the housing 3. For example, the protection circuit 5 is connected directly in series with the electrical installation. Advantageously, the fuse element 17 is then housed in a fusible cartridge, which is preferably filled with sand.

Each characteristic described above for one embodiment or a variant can be implemented in the other embodiments and variants described above, insofar as this is technically possible.

1. A protection circuit for an electrical installation, the protection circuit comprising:
a first terminal;
a second terminal, separate from the first terminal;
a fuse element, which is disposed between the first terminal and the second terminal, and which has two opposite ends, the two ends including a first end, which is connected to the first terminal, and a second end, the fuse element being configured to melt when an electric current flowing between the first end and the second end exceeds a predetermined critical current that is characteristic of the fuse element; and
a resistive element, which is arranged between the first terminal and the second terminal, which has two opposing leads, including a first lead and a second lead, the first lead being connected to the first terminal;
wherein:
the second end is connected to the second lead;
the protection circuit further comprises:
a movable contact, which is arranged between the second lead and the second terminal and which is configured to switch between a closed position, in which the movable contact electrically connects the second lead to the second terminal, and an open position, in which the movable contact is at a distance from the second lead and does not electrically connect the second lead to the second terminal;
a return member, which tends to move the movable contact from the closed position to the open position, and
a soldering point, which is configured to hold the movable contact in the closed position when the soldering point in not melted, and to allow the movable contact to move from the closed position to the open position under the effect of the return member when the soldering point is melted.

2. The protection circuit according to claim 1, wherein the resistive element is a non-linear resistor.

3. The protection circuit according to claim 2, wherein the resistive element is a metal oxide varistor.

4. The protection circuit according to claim 3, wherein:
the resistive element has a rated voltage, referred to as the first rated voltage, which is strictly lower than a rated voltage of the protection circuit, referred to as the second rated voltage, and
the resistive element is configured to generate sufficient heat to melt the soldering point when a voltage greater than the first nominal voltage is applied between the first lead and the second lead.

5. The protection circuit according to claim 4, wherein the first rated voltage is between 30% and 70% of the second rated voltage.

6. The protection circuit according to claim 1, wherein the protection circuit comprises:
a movable arc shield between:
an engaged position, in which the arc shield is interposed between the resistive element and the movable contact in the open position, preventing the movable contact from moving from the open position to the closed position, and
a retracted position, in which the arc shield does not prevent the movable contact from moving from the open position to the closed position,
a secondary return member, which is configured to return the arc shield from its retracted position to the engaged position.

7. The protection circuit according to claim 1, wherein the protection circuit is configured to have a resistance greater than 1 GΩ when the movable contact is in the open position.

8. A protection device for an electrical installation, comprising:
a housing, which is made of an electrically insulating material and which delimits a cavity, the cavity comprising a first opening and a second, separate opening; and
an example of the protection circuit according to claim 1, the protection circuit being housed in the cavity, the first terminal being positioned at the first opening and the second terminal being positioned at the second opening.

9. The protection device according to claim 8, wherein:
the protection device further comprises a powdered material, in particular sand, which at least partially fills the cavity and is intended to help quench an electric arc.

10. A method for protecting an electrical installation, the protection method being implemented with the electrical circuit according to claim 1, the protection method comprising the following steps:
an initial step, during which a current flowing between the first terminal and the second terminal is less than the critical current and flows through the fuse element and the movable contact;
a first melting step, starting when the current becomes greater than the critical current, comprising a melting of the fuse element;
a breaking step, starting when the fuse element breaks, causing an arc voltage to be established between the first lead and the second lead;
a second melting step, starting when the fuse element is melted following the first melting step, comprising a circulation of at least of the leakage current between the first terminal and the second terminal through the resistive element and the movable contact, the resistive element generating heat, causing the soldering point to heat up and then melt as a result of the heat generated by the resistive element;
a switchover step, starting when the soldering point is melted, comprising the switching over the movable contact to the open position.

11. The protection method according to claim 10, wherein:
the protection circuit comprises:
a movable arc shield between:
an engaged position, in which the arc shield is interposed between the resistive element and the movable contact in the open position, preventing the movable contact from moving from the open position to the closed position, and
a retracted position, in which the arc shield does not prevent the movable contact from moving from the open position to the closed position, and
a secondary return member, which is configured to return the arc shield from its retracted position to the engaged position; and
the method further comprises a securing step, which begins when the movable contact moves into the open position and which comprises moving the arc shield from the retracted position to the engaged position.

12. The protection method according to claim 10, the protection method being further implemented with a protection device for an electrical installation, comprising:
a housing, which is made of an electrically insulating material and which delimits a cavity, the cavity comprising a first opening and a second, separated opening; and
the protection circuit being housed in the cavity, the first terminal being positioned at the first opening and the second terminal being positioned at the second opening.
